(19) United States
(12) Patent Application Publication
(10) Pub. No.: US 2026/0015987 A1
(43) Pub. Date: Jan. 15, 2026

(54) ENERGY STORAGE WITH COMPRESSED GAS USING HYDRAULIC TRANSFORMERS

(71) Applicant: Energy Internet Corporation, Saratoga, CA (US)

(72) Inventors: Bhamidipati Venkata Suryanarayana Sastry, Bangalore – 560 103 (IN); Shankar Ramamurthy, Saratoga, CA (US); Benjamin Rush Roberts, Los Altos, CA (US); Murali Sundaresan, Sunnyvale, CA (US); Mark Jennings Weathers, Phoenix, AZ (US)

(73) Assignee: Energy Internet Corporation, Saratoga, CA (US)

(21) Appl. No.: 19/039,873

(22) Filed: Jan. 29, 2025

Related U.S. Application Data
(60) Provisional application No. 63/626,555, filed on Jan. 30, 2024.
(60) Provisional application No. 63/627,100, filed on Jan. 31, 2024.
(60) Provisional application No. 63/698,590, filed on Sep. 25, 2024.

(51) Int. Cl. F03B 13/06

(52) U.S. Cl. CPC F03B 13/06

(57) ABSTRACT

Techniques for using a pressurized gas for energy storage are disclosed. An energy storage system (ESS) comprising a prime mover, a liquid reservoir, hydraulic transformers (HTs), and tubular bundle modules (TBMs) is accessed. The reservoir is coupled to the prime mover and the HTs. The coupling includes filling the prime mover and the HTs with liquid. The prime mover liquid is pressurized at a first pressure, sending liquid to a TBM and an HT. The TBM compresses a gas to a first pressure, using the first pressure liquid. The gas at a first pressure is sent to a second TBM. The liquid at a first pressure is further pressurized to a second pressure. The liquid is sent to a second TBM. The gas at a first pressure is further compressed, resulting in a gas at a second pressure. The second pressure gas is stored in a high-pressure tank.

### RELATED APPLICATIONS

This application claims the benefit of U.S. provisional patent applications “Energy Storage With Compressed Gas Using Hydraulic Transformers” Ser. No. 63/626,555, filed Jan. 30, 2024, “Pressurized Ammonia Processing” Ser. No. 63/627,100, filed Jan. 31, 2024, and “Monolithic Manifold Joining Using Integrated Casting” Ser. No. 63/698,590, filed Sep. 25, 2024.

Each of the foregoing applications is hereby incorporated by reference in its entirety.

### FIELD OF ART

This application relates generally to storing energy and more particularly to energy storage with compressed gas using hydraulic transformers.

### BACKGROUND

Fossil fuels, including oil, coal, and natural gas, have significantly contributed to the growth of nations and societies across the globe. Their use has been an integral part of transportation, industrialized agriculture, and the provision of electrical and mechanical power to our modern civilizations. The industrial revolution was largely powered by coal and steam power, leading to unprecedented economic growth and technological advancement. Oil and its derivatives have enabled mass-scale travel by car, airplane, and ship, enabling global travel and trade. Natural gas is a critical source of electricity generation, replacing coal in many power plants across the country. While fossil fuels are still readily available, their use has become a source of great concern in recent years. Burning fossil fuels releases large quantities of carbon dioxide and other greenhouse gases, contributing to a slow but significant increase in the mean temperature of the planet. As a result, melting glaciers and ice packs are contributing to rising sea levels. Weather across the planet is more extreme, with heatwaves, droughts, floods, and wildfires increasing in frequency and intensity. Oceans are becoming more acidic as more carbon dioxide is absorbed into the water, changing the environment for marine life and altering whole ecosystems.

In response, many nations and international organizations are working to develop alternatives to fossil fuels for energy production. At the same time, efforts are underway to increase the efficiency of fossil fuel use, and to lower the overall use of fossil fuel generated energy where and when possible. Solar power is now widely used in homes and businesses in many areas of the country. Photovoltaic (PV) solar cells convert sunlight directly into electricity using solar panels. Solar thermal panels use sunlight to heat water or other fluids for heating and cooling buildings and generating electricity.

Wind power is used on an industrial scale to generate electricity using wind turbine farms. Over ten percent of the total electricity generated in the U.S. comes from wind power. Hydroelectric power is generated in many parts of the world, using the force of moving water to drive turbines to generate electricity. Fifteen percent of the world's electricity comes from this renewable energy source. Geothermal energy plants harvest heat from the Earth to generate electricity and provide direct heating. While this is a renewable energy source, its use is limited by geography and the high cost of building geothermal facilities. Only 0.3% of the world's electricity comes from geothermal sources. Bioenergy facilities derive power from organic matter such as wood, algae, and agricultural waste. Over one percent of U.S. energy comes from bioenergy sources. Tidal and wave energy facilities capture the energy of ocean tides and waves to generate electricity. While the amount of energy we currently derive from tide and wave facilities is quite small at present, there is significant potential for growth in this sector.

Nuclear energy has been used for many years, both in sea vessels and land-based facilities. It has many advantages, including low carbon emissions, high energy density, continuous operations, and efficiency of land use. However, there are also significant disadvantages. Radioactive waste from nuclear facilities makes safe, long-term storage a significant challenge. Safety concerns over accidents make the public wary and, in many cases, reluctant to develop new plants. Construction of nuclear power plants is expensive and can take several years to complete. As our desire to move away from fossil fuels continues, interest in all of these alternatives will grow, as will our ability to use them more efficiently and effectively.

### SUMMARY

Disclosed techniques address energy storage using gas that is pressurized employing hydraulic transformers. An energy storage system (ESS) is accessed. The ESS comprises a prime mover, a liquid reservoir, N hydraulic transformers (HTs), and N+1 tubular bundle modules (TBMs). The N HTs are interconnected with piping and computer-controlled switch valves. An input and an output of each of the N HTs are coupled to a preceding TBM and a succeeding TBM, both within the N+1 TBMs. The liquid reservoir is coupled to the prime mover and the N HTs. The coupling includes filling a chamber within the prime mover with a liquid from the liquid reservoir and filling a chamber within each of the N HTs with the liquid from the liquid reservoir. The liquid can include fresh water, soft water, or sea water. The liquid within the chamber of the prime mover is pressurized. The pressurizing, achieved by applying a weight to a piston that pressurizes the liquid, results in a liquid at a first liquid pressure. The pressurizing sends the liquid at a first liquid pressure to a first TBM within the N+1 TBMs and a first HT within the N HTs. A gas is compressed by the first TBM, using the liquid at a first liquid pressure. The gas can include atmospheric air, nitrogen, etc. The compressing produces a gas at a first gas pressure, and the gas at a first gas pressure is sent to a second TBM. The liquid at a first liquid pressure is further compressed by the first HT, resulting in a liquid at a second pressure. The further pressurizing includes sending the liquid at a second liquid pressure to a second TBM within the N+1 TBMs. The gas at a first gas pressure is further compressed by a second TBM within the N+1 TBMs, using the liquid at a second liquid pressure. The further compressing results in a gas at a second gas pressure. The second pressure is a multiple of the first pressure. The gas at a second gas pressure is stored in a high-pressure gas storage tank. The storage tank can include an above ground tank, an underground tank, or some other high pressure storage vessel.

A method for storing energy is disclosed comprising: accessing an energy storage system (ESS), wherein the ESS comprises a prime mover, a liquid reservoir, N hydraulic transformers (HTs), and N+1 tubular bundle modules (TBMs), wherein the N HTs are interconnected with piping and computer-controlled switch valves, and wherein an input and an output for each of the N HTs are coupled to a preceding TBM within the N+1 TBMs and a succeeding TBM within the N+1 TBMs; coupling the liquid reservoir to the prime mover and the N HTs, wherein the coupling includes filling a chamber within the prime mover with a liquid from the liquid reservoir and filling a chamber within each of the N HTs with the liquid from the liquid reservoir; pressurizing the liquid within the chamber of the prime mover, wherein the pressurizing results in a liquid at a first liquid pressure wherein the pressurizing sends the liquid at a first liquid pressure to a first TBM within the N+1 TBMs and a first HT within the N HTs; compressing by the first TBM, using the liquid at a first liquid pressure, a gas, wherein the compressing produces a gas at a first gas pressure, and wherein the gas at a first gas pressure is sent to a second TBM; further pressurizing, by the first HT, the liquid at a first liquid pressure, wherein the further pressurizing results in a liquid at a second pressure, wherein the further pressurizing includes sending the liquid at a second liquid pressure to a second TBM within the N+1 TBMs; further compressing, by a second TBM within the N+1 TBMs, using the liquid at a second liquid pressure, the gas at a first gas pressure, wherein the further compressing results in a gas at a second gas pressure; and storing, in a high pressure gas storage tank, the gas at a second gas pressure. In embodiments, the pressurizing and the further pressurizing occur simultaneously. In embodiments, the compressing and the further compressing occur simultaneously. In embodiments, the ESS includes a second HT, wherein the second HT converts the liquid at a second liquid pressure to a liquid at a third liquid pressure.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy storage with compressed gas using hydraulic transformers.

FIG. 2 is a flow diagram for continuous operation of an ESS.

FIG. 3 is a block diagram of a prime piston within a prime mover.

FIG. 4 is a block diagram for pressurizing a liquid with a hydraulic transformer.

FIG. 5 is an example of compressing a gas with a tubular bundle module.

FIG. 6 is a block diagram for an energy storage system.

FIG. 7 is a system diagram for energy storage with compressed gas using hydraulic transformers.

### DETAILED DESCRIPTION

Energy generation is shifting focus from traditional, fossil fuel-based production to renewable or “green” sources. These sources can be used to produce various forms of energy, primarily electrical energy. The sources are used to address energy consumption demands when the demands occur. However, energy demands usually fluctuate over a given period of time, resulting in dynamic differences between energy production and energy consumption. The energy production and demand differences can further depend on differing timeframes, such as day versus night, a day of the week, manufacturing and transportation schedules, payroll processing, seasonal factors such as heating or cooling, and so on. The discrepancies between energy production and energy consumption can be significant and are at times critical. The discrepancies can be correlated to time-dependent energy demands, changeable energy production capabilities such as the presence or absence of a renewable resource used to generate the energy, available capacity of commercial or grid power, amount of standby or backup energy, etc. To ameliorate the asymmetry between energy production and consumption, generated energy that exceeds demand at a given time can be stored for later use. The stored energy can be recovered when demand exceeds a given power generation level or supply capability. Energy can be collected and stored when a renewable resource is available, when the available energy exceeds energy need, or even when the cost of production of the energy is relatively inexpensive. The stored energy can be used to augment available energy or to fully provide the amount of energy that is needed during periods of increased or otherwise unmet energy need. The recovery of stored energy can be applied to low-level energy demand scenarios, such as the energy needs of a house or small farm operation, to larger scale energy needs such as the energy needs for manufacturing, or even to the largest energy needs such as an energy distribution grid.

Techniques for storing energy using a pressurized gas are disclosed. The gas is compressed using hydraulic transformers. The storing energy can be managed, where the storing energy can include a pressurized liquid such as soft water or sea water. The pressurized liquid can be used to compress a gas such as environmental air or nitrogen. The pressurizing the liquid can be accomplished within a chamber within a prime mover. The pressurizing can be accomplished using mass coupled to a piston, where the piston pressurizes the liquid to a first liquid pressure. The pressurized liquid is sent to a tubular bundle module and to a hydraulic transformer. The compressing the gas is accomplished using the tubular bundle module to compress the gas to a first gas pressure. The compressed gas is sent to a second tubular bundle module. The liquid can be further pressurized to a second liquid pressure. The second liquid pressure is used to compress the gas from the first gas pressure to a second gas pressure. The pressurizing, further pressurizing, compressing, and further compressing can be accomplished using energy such as renewable, “green” electrical energy. The gas at the second gas pressure is stored in a high-pressure tank. The stored compressed air can be extracted from the high-pressure storage tank and used to produce energy. The produced energy can include electrical energy resulting from using the compressed gas at the second pressure to spin a turbine.

Energy with intermittent availability or energy in excess of need can be stored or cached when the energy is being produced. The stored energy can later be extracted when the stored energy is needed to meet demand. A similar strategy can be used based on price, where energy is stored when production cost is low, then later extracted when the energy production cost is high. The stored energy can be used in various combinations with other energy sources such as grid power or microgrid (e.g., locally generated) power to meet energy demands at given times. The renewable, “green” energy can be used to pressurize liquid using a chamber within a prime mover, and to compress a gas using subsequent tubular bundle modules and hydraulic transformers. The compressed gas can be stored in a high-pressure tank or vessel. Energy storage can be based on a period of time, where the period of time can be a short-term basis or a long-term basis. Energy losses are introduced when converting energy from one energy type to another energy type. Further losses occur due to friction when storing energy, extracting energy, routing energy, etc. Minimizing the energy losses is critical to any energy storage and retrieval/recovery technique. Electrical energy storage is possible using techniques such as mature storage battery technologies, but the costs of large battery banks are prohibitive in terms of both up-front expense and maintenance costs. Further, batteries are problematic for long-term storage purposes because of charge leakage.

In disclosed techniques, storing energy is accomplished with compressed gas using hydraulic transformers. Renewable “green” energy is used to pressurize a liquid and to compress a gas. The pressurized liquid can be further pressurized. The further pressurized liquid can further compress the gas. Each time the gas is further compressed, the resulting pressure is a multiple of the previous pressure such as 2×, 3×, 5×, and so on. Thus, the gas can be compressed to a number of atmospheres or bars such as 125 bar or 500 bar. The energy used for the pressurization of the liquid and the compression of the gas can be obtained locally using onsite capabilities such as an onsite microgrid based on renewable energy. Alternatively, the energy can be obtained from farther afield using a larger grid such as a regional or national grid. The “nongreen” energy can be generated using fuels such as coal, natural gas, nuclear sources, hydropower, or geothermal energy. The green energy can be obtained using renewable sources such as solar, wind, tidal, wave action, and the like. Other energy sources can include pump-turbine sources such as compressed air, steam, or ice; backup power sources such as diesel-generator sets; and so on.

An energy storage system (ESS) is accessed. The ESS includes a prime mover for pressurizing a liquid. The liquid can include surface water, deionized water, soft water, seawater, and so on. The ESS further includes a liquid reservoir for the liquid, a number N of hydraulic transformers (HTs), and a number N+1 of tubular bundle modules (TBMs). The HTs are interconnected with piping and computer-controlled switch valves. An input and an output of each of the N HTs are coupled to a preceding TBM within the N+1 TBMs and a succeeding TBM within the N+1 TBM. The liquid reservoir is coupled to the prime mover and the N HTs. The coupling includes filling a chamber within the prime mover with a liquid from the liquid reservoir and filling a chamber within each of the N HTs with the liquid from the liquid reservoir. The liquid is pressurized within the chamber of the prime mover, resulting in a liquid at a first liquid pressure. The pressurizing sends the liquid at a first liquid pressure to a first TBM and a first HT. A gas is compressed by the first TBM, using the liquid at a first liquid pressure. The gas can include atmospheric air, nitrogen, and so on. The compressing produces a gas at a first gas pressure, and the gas at a first gas pressure is sent to a second TBM. The liquid at a first liquid pressure is further pressurized by the first HT. The further pressurizing results in a liquid at a second pressure. The further pressurizing includes sending the liquid at a second liquid pressure to a second TBM. The gas at a first gas pressure is further compressed by a second TBM, sending the liquid at a second liquid pressure. The further compressing results in a gas at a second gas pressure. The gas at a second gas pressure is stored in a high-pressure gas storage tank.

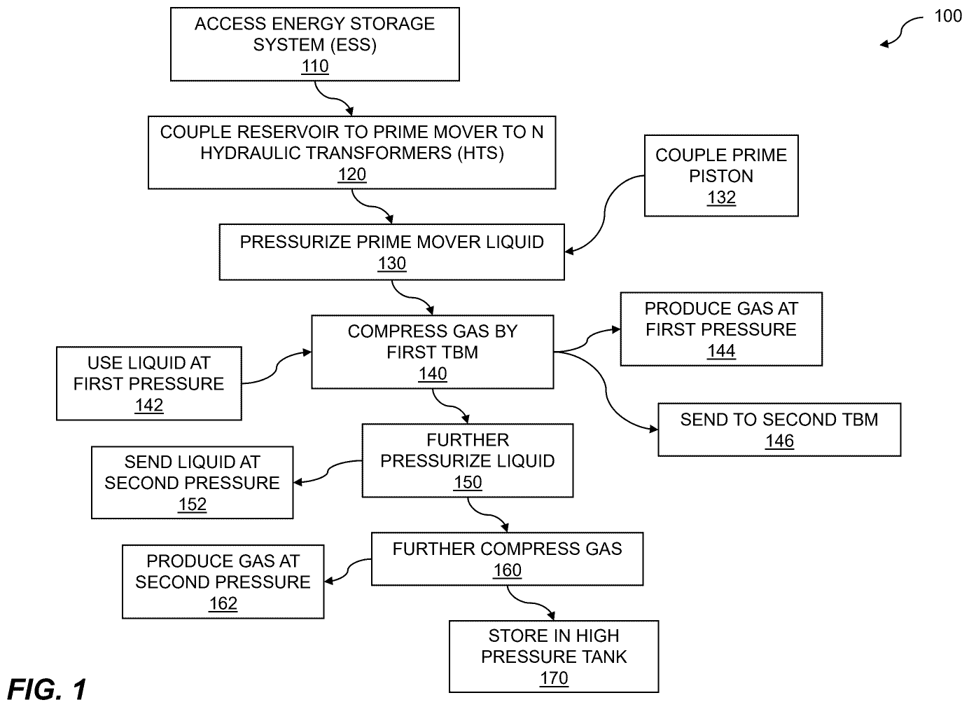

FIG. 1 is a flow diagram for energy storage with compressed gas using hydraulic transformers. The compressed gas can be used for energy storage, recovery, and management. A gas processing subsystem can store various forms of energy such as renewable or “green” electrical energy by storing the energy as a compressed gas. The compressed gas can be stored in enclosures such as high-pressure gas storage tanks, high-pressure vessels, and so on. The compressed gas energy storage subsystem can be a standalone system which uses green energy to generate the compressed gas, to store the compressed gas, and to use the compressed gas to generate energy such as electrical energy. The compressed gas energy storage subsystem can be part of a large energy storage subsystem, where the energy storage subsystem can include multiple batteries or capacitors; pressurized storage elements such as high-pressure water, pressurized air, steam, or ice-water slurry; and the like. A liquid is pressurized, where the liquid can include water, soft water, saltwater, and so on. A gas is compressed to produce a compressed gas at a first pressure. The compressed gas can be further compressed to a second gas pressure, a third gas pressure, etc. The compressing and the further compressing can occur simultaneously. The compressed gas is stored in an enclosure such as a high-pressure storage tank. The compressed gas can be released from the enclosure to spin a turbine, a pump-turbine, and the like. The spinning turbine can be used to generate energy such as electrical energy. Prior to spinning a turbine, the released gas can be sent to various units such as a purification unit, a filter unit, a drying unit, and so on.

The flow 100 includes accessing an energy storage system (ESS) 110. The energy storage system can store one or more types of energy such as electrical energy, thermal energy, mechanical energy pressurized liquid, compressed gas, and so on. The ESS includes a variety of elements including a prime mover, a liquid reservoir, N hydraulic transformers (HTs), and N+1 tubular bundle modules (TBMs). In embodiments, the prime mover can include a prime piston. The prime piston can include a weight coupled to a piston that can pressurize a liquid (described below). The prime piston can comprise a gravity piston. The prime mover can comprise a motor-driven pump to provide the liquid at the first pressure. The N HTs can each comprise a two-chamber double-acting linear piston pressure volume exchanger. The linear piston pressure volume exchanger enables a constant inverse relationship of flow rate and pressure due to the inherent physics of two different piston face diameters (described below). The constant inverse relationship allows the leveling out of the power generated (running in expansion mode) or consumed (running in compression mode) over the entire operating cycle. In embodiments, the two-chamber double-acting linear piston pressure volume exchanger enables power leveling over an entire operating cycle.

The relative volumes of the chambers can be based on a ratio such as 5:1, 10:1, 100:1, etc. The elements can be colocated on a movable platform, installed near sources of liquid and gas, and the like. The ESS can further include a high-pressure gas storage tank for storing a compressed gas (discussed below). The N HTs are interconnected with piping and computer-controlled switch valves. The piping and the computer-controlled switch valves can control and direct the flow of liquid, pressurized liquid, gas, and compressed gas. An input and an output of each of the N HTs are coupled to a preceding TBM within the N+1 TBMs and a succeeding TBM within the N+1 TBMs. The HTs can be “daisy chained” together in a series configuration, as can the TBMs. In other embodiments, the ESS provides substantially isothermal operation. Substantially isothermal operation can include 95% or higher isothermal operation. In other embodiments, the N HTs can include a two-chamber double-acting linear piston pressure volume exchanger.

The flow 100 includes coupling the liquid reservoir 120 to the prime mover and the N HTs. Discussed above, the coupling can be accomplished using piping and computer-controlled-switch valves. The coupling includes filling a chamber within the prime mover with a liquid from the liquid reservoir and filling a chamber within each of the N HTs with the liquid from the liquid reservoir. The liquid can be obtained from one or more local sources such as surface water, ground water, a lake or pond, a river or stream, and so on. The liquid can be filtered prior to filling the chamber within the prime mover and a chamber within each of the N HTs. In embodiments, the liquid can include soft water. The soft water can include an amount of calcium carbonate such as 0-3 grains per gallon of water. In other embodiments, the liquid can include seawater. The seawater can be filtered to remove debris, plants, animals, etc.

The flow 100 includes pressurizing the liquid 130 within the chamber of the prime mover. The pressurizing the liquid can include pressurizing the liquid within the chamber of the prime mover. The pressurizing can be accomplished by the weight and/or the coupled prime piston 132 associated with the prime mover. The prime piston can comprise a gravity piston. The weight can force movement of the prime piston which can pressurize the liquid within the chamber. The weight can comprise concrete, metal, alloy, and so on. In embodiments, the prime mover includes a prime piston. The prime piston can be raised to a position suitable to accomplish the pressurizing. The motor can include an electric motor. The electric motor can drive the prime piston using cables, a crankshaft, a connecting rod, and so on. The electric motor can be powered by one or more green electrical energy sources such as solar, wind, wave action, and so on. Additional prime pistons can be included in the prime mover. The pressurizing results in a liquid at a first liquid pressure. The first liquid pressure can be measured in bar units. The pressurizing sends the liquid at a first liquid pressure to a first TBM within the N+1 TBMs and a first HT within the N HTs.

The flow 100 includes compressing 140, by the first TBM, a gas. In the flow 100, the compressing is accomplished using the liquid 142 at a first liquid pressure. The compressing can be accomplished using a liquid piston, where the pressurized liquid used to compress the gas is in contact with the gas. The gas can include atmospheric air, filtered air, nitrogen, and so on. The gas can include a gas chosen that minimally dissolves or absorbs into the liquid. In the flow 100, the compressing produces a gas at a first gas pressure 144. The pressure of the gas at the first pressure can include a few bar, tens of bars, and so on. In the flow 100, the gas at a first gas pressure is sent 146 to a second TBM. The sending can be accomplished using the interconnecting piping and computer-controlled switch valves. The sending the gas at the first pressure to a second TBM can accomplish further compression of the gas (discussed below).

The flow 100 includes further pressurizing 150, by the first HT, the liquid at a first liquid pressure. In embodiments, the pressurizing and the further pressurizing occur simultaneously. The further pressurizing results in a liquid at a second pressure. In embodiments, the pressure of the liquid at a second liquid pressure is higher than the pressure of the liquid at a first liquid pressure. The second liquid pressure can be based on a multiple, factor, ratio, and so on of the first liquid pressure. The ratio can include ratios such as 5:1, 10:1, 100:1, and the like. In the flow 100, the further pressurizing includes sending 152 the liquid at a second liquid pressure to a second TBM within the N+1 TBMs. The sending the liquid at the second liquid pressure can be accomplished using the interconnected piping, the computer-controlled switch valves, and so on. A flow controller, the computer-controlled switch valves, and other electrochromic and electrical equipment can be powered using green energy. In other embodiments, the pressurizing and the further pressurizing can occur simultaneously. The liquid can be further pressurized.

The flow 100 includes further compressing 160, by a second TBM within the N+1 TBMs, using the liquid at a second liquid pressure, the gas at a first gas pressure. In embodiments, the compressing and the further compressing can occur simultaneously. In the flow 100, the further compressing results in a gas at a second gas pressure 162. The second gas pressure and the gas pressure can be based on a ratio such as 5:1, 10:1, 100:1, etc. In embodiments, the pressure of the gas at a second gas pressure can be higher than the pressure of the gas at a first gas pressure. In other embodiments, the compressing and the further compressing can occur simultaneously. The pressurized liquid can be further compressed, and the compressed gas can be further compressed. In embodiments, the ESS includes a second HT, wherein the second HT converts the liquid at a second liquid pressure to a liquid at a third liquid pressure.

The flow 100 includes storing 170, in a high-pressure gas storage tank, the gas at a second gas pressure. The high-pressure gas storage tank can include an insulated tank, a pressure vessel, and so on. The high-pressure tank can be placed on a surface such as the ground, on a tower or platform, within a buried tank, in a subterranean cavern, in an underwater tank or vessel, and so on.

The pressurizing, the further pressurizing, the compressing, and the further compressing components can be reset. Further embodiments can include refilling the chamber within the prime mover with a liquid from the liquid reservoir and refilling the chamber within each of the N HTs with the liquid from the liquid reservoir. The pressurizing, further pressurizing, compressing, and further compressing can be repeated. The refilling can be accomplished while a reciprocal ESS, described later, provides compressed gas to the storage tank, which allows continuous operation of the system. More than one reciprocal ESS can be included in the overall ESS, each one providing compressed gas in a phased, or staged, manner. In embodiments, a reciprocal ESS can be coupled to the ESS to provide continuous gas compression and expansion operations.

The ESS can be run in “reverse mode” to allow extraction of the energy stored as a high-pressure compressed gas. The ESS is essentially run in reverse, using the same componentry. The high-pressure gas within the high-pressure storage tank can be extracted from the tank and used to generate energy. The energy extraction can be accomplished by expanding the high-pressure gas. The expansion can include filling a tubular bundle module from the liquid reservoir, from a lower pressure stage, and so on. The liquid within the TBM can be pressurized using gas from a higher-pressure stage. The gas from the higher-pressure stage can include the compressed gas within the high-pressure storage tank. The high-pressure gas can further send the liquid within the TBM to a lower pressure stage. When a target gas volume has been reached, a computer-controlled switch valve can be closed. The liquid can continue to be sent to lower pressure stage. When the TBM has been emptied of the liquid, the TBM can be refilled with liquid from a lower pressure stage. The remaining gas can also be sent to a lower pressure stage. The “forward mode” that provides compression and the “reverse mode” that provides expansion can be implemented using the same hardware. For example, if energy from a solar farms is being stored as a high-pressure compressed gas during the day using the ESS, at night, the ESS can be used to extract that energy and provide power to a grid, a microgrid, an industrial complex, a city, and so on. Some embodiments comprise releasing compressed gas from the high-pressure gas storage tank back into the ESS running in expansion mode. Some embodiments comprise extracting energy from the ESS running in expansion mode.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

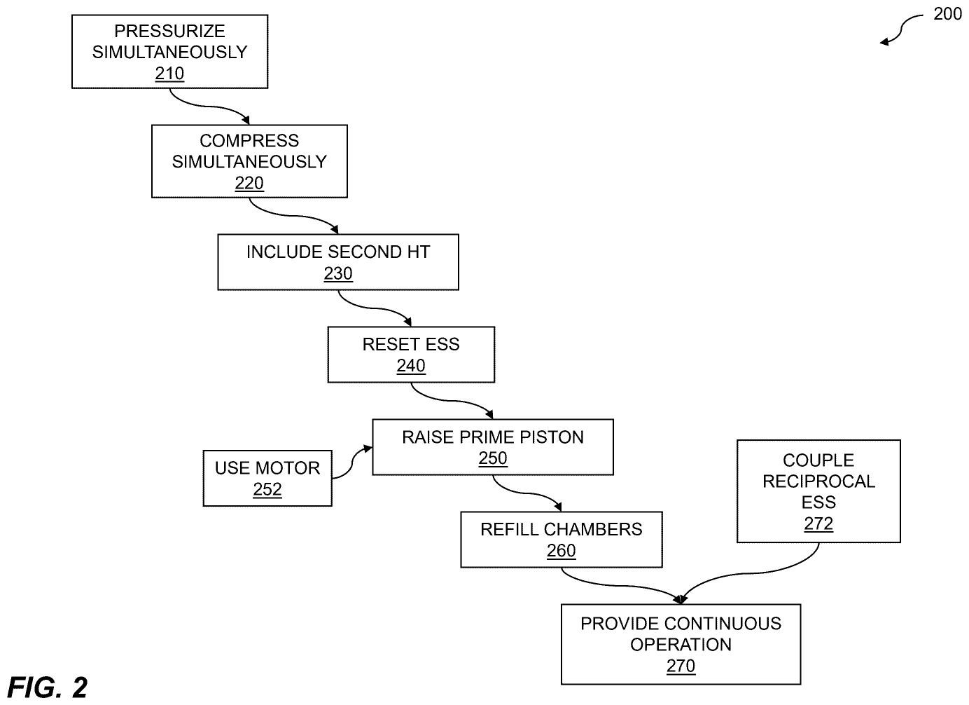

FIG. 2 is a flow diagram for continuous operation of an ESS. Continuous operation augments energy storage with compressed gas using hydraulic transformers. An energy storage system (ESS) comprising a prime mover, a liquid reservoir, hydraulic transformers (HTs), and tubular bundle modules (TBMs) is accessed. The reservoir is coupled to the prime mover and the HTs. The coupling includes filling the prime mover and the HTs with liquid. The prime mover liquid is pressurized at a first pressure, sending liquid to a TBM and an HT. The TBM compresses a gas to a first pressure, using the first pressure liquid. The gas at a first pressure is sent to a second TBM. The liquid at a first pressure is further pressurized to a second pressure. The liquid is sent to a second TBM. The gas at a first pressure is further compressed, resulting in a gas at a second pressure. The second pressure gas is stored in a high-pressure tank.

The flow 200 includes pressurizing simultaneously 210 the liquid within the chamber of the prime mover and the liquid in the first HT. As discussed above and throughout, the N HTs are interconnected with piping and computer-controlled switch valves. The piping and the computer-controlled switch valves can control and direct the flow of liquid, pressurized liquid, gas, and compressed gas. An input and an output of each of the N HTs are coupled to a preceding TBM within the N+1 TBMs and a succeeding TBM within the N+1 TBMs. The HTs can be “daisy chained” together in a series configuration, as can the TBMs. The first HT can therefore be pressurized by the “further pressurizing,” while the prime mover chamber is being pressurized at the same time by the “pressurizing.” Thus, in embodiments, the pressurizing and the further pressurizing occur simultaneously. The flow 200 includes compressing simultaneously 220 the gas within the first TBM and the gas within the second TBM. Piping and computer-controlled switch valves can direct and control the compressed gases within the ESS. The daisy-chained approach enables the simultaneous compressing of the gases in the TBMs. In embodiments, the compressing and the further compressing occur simultaneously.

The flow 200 includes including a second HT 230. The second HT can extend the daisy chain of HTs previously described such that the input of the second HT is the liquid at the second pressure, and the liquid leaving the second HT is pressurized to a third pressure. These pressures along the daisy chain can each provide a pressure boost, until a desired final liquid pressure is produced at the output of the Nth HT. In embodiments, the ESS includes a second HT, wherein the second HT converts the liquid at a second liquid pressure to a liquid at a third liquid pressure.

The flow 200 includes resetting the ESS 240. The resetting can “zero out” the prime mover, the TBMs, and the HTs to allow a new cycle of pressurizings and compressings to begin. To begin the new cycle once the ESS is reset, the prime piston can be raised 250. Recall that the prime mover can comprise a prime piston, and the prime piston can use a motor 252 to drive the prime piston and effect the pressurizing. The resetting the ESS can include moving the prime piston. Thus, some embodiments comprise resetting the ESS, and some embodiments comprise moving, with a motor, the prime piston. The flow 200 includes continuing the cycle by refilling the chambers 260. After the pressurizing, the further pressurizing, the compressing, and the further compressing is complete, and the components are reset, the chambers can be refilled with liquid from a reservoir to enable the next cycle to begin. Some embodiments comprise refilling the chamber within the prime mover with a liquid from the liquid reservoir and refilling the chamber within each of the N HTs with the liquid from the liquid reservoir. The pressurizing, further pressurizing, compressing, and further compressing can be repeated.

The flow 200 includes providing continuous operation 270 of the ESS. The continuous operation can be enabled by reservoirs of liquid that are pumped into the chambers that need refilling. A reciprocal ESS can be coupled 272 to the ESS. The reciprocal ESS can provide compression out of phase from the ESS. In other words, while the ESS is being reset and refilled in order to get ready for its next compression cycle, the reciprocal ESS provides compressed gas to the storage tank in a continuous manner. More than one reciprocal ESS can be used to provide finer granularity of the phase relationship between the ESS and one or more reciprocal ESSs. For example, an ESS and three reciprocal ESSs, for a total of four ESSs, can be used to each cover one quarter of the four-cycle TBM operation, discussed later. In embodiments, a reciprocal ESS is coupled to the ESS to provide continuous gas compression and expansion operations.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

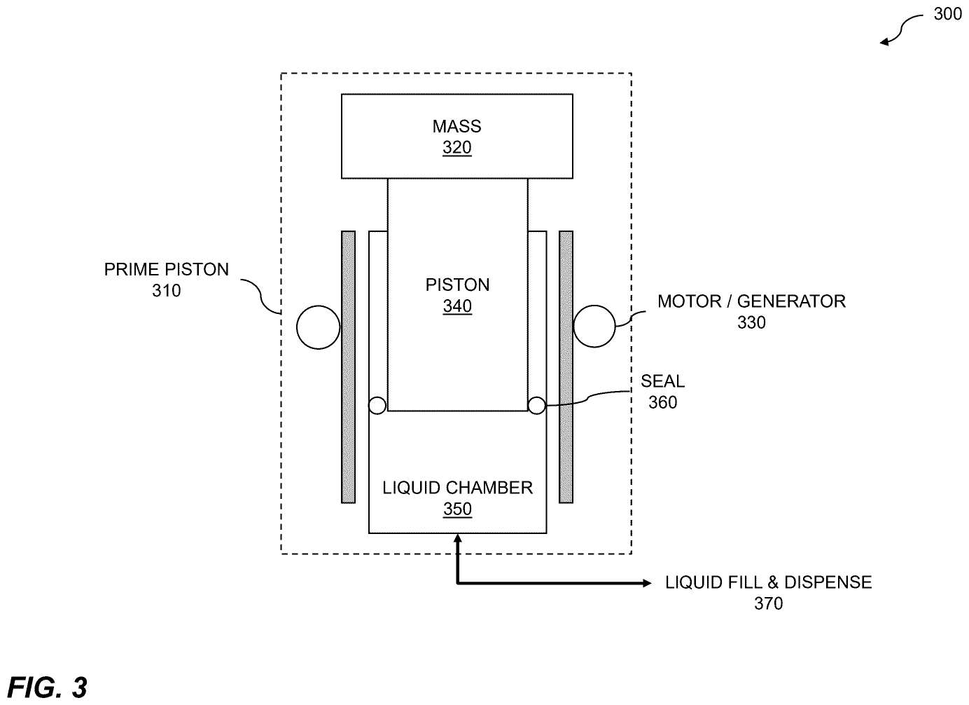

FIG. 3 is a block diagram of a prime piston within a prime mover. The prime piston can include a mass that can be coupled to a piston. The mass and the piston can pressurize a liquid within a liquid chamber. The prime piston enables energy storage with compressing gas using hydraulic transformers. A block diagram for a prime piston within a prime mover is shown. The prime mover can include a prime piston 310. The prime piston can be used to pressurize a liquid. The prime piston can pressurize a liquid by setting a mass 320 to a height h. The mass can comprise the piston itself. The mass can comprise concrete, metal, an alloy, and so on placed on top of the prime piston. The block diagram 300 includes a motor/generator 330. The motor/generator can be used to lift the mass to the height h. The mass can then be released from the height h, where gravity will act on the mass, drawing the mass downward. As the mass is descending, the motor/generator can regenerate electrical energy. The electrical energy that results from the regeneration can be stored for later use. The mass is coupled to a piston 340. As the mass descends, the piston can pressurize a liquid within a liquid chamber 350. The liquid can include fresh water, soft water, seawater, and the like. The interface between the surface of the piston and the surface of the liquid chamber can be sealed. The sealing can be accomplished using a seal 360. The seal can enable the piston to lower into the liquid chamber, thereby enabling pressurizing of the liquid within the chamber. The seal further prevents the pressurized liquid from leaking out of the liquid chamber by escaping around the piston. The liquid chamber can be filled with liquid 370 from a liquid reservoir using piping. The reservoir can include a tank, a lake or pond, a river or stream, the ocean, and so on. The pressurized liquid within the tank can be dispensed using the same piping that is used to fill the tank.

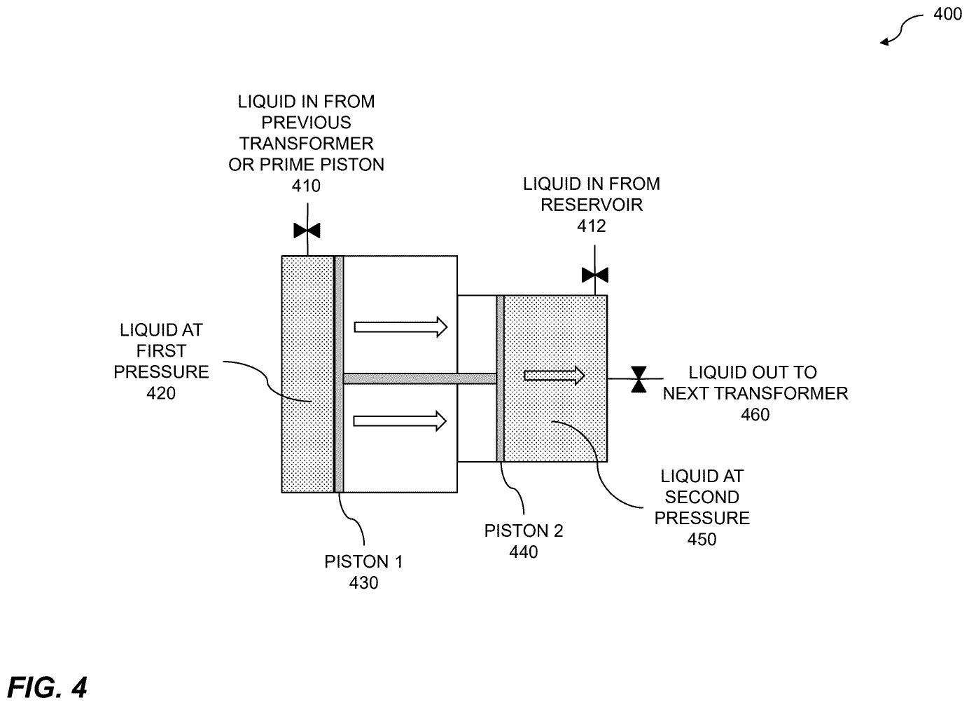

FIG. 4 is a block diagram for pressurizing a liquid with a hydraulic transformer. The hydraulic transformer can be used to “transform” a liquid at a first liquid pressure to a liquid at a second liquid pressure. The second liquid pressure can be higher than the first liquid pressure. One or more hydraulic transformers can be used to pressurize a liquid to a pressure suitable for compressing a gas for storage in a high-pressure storage tank. The one or more hydraulic transformers enable energy storage with compressed gas. An energy storage system (ESS) comprising a prime mover, a liquid reservoir, hydraulic transformers (HTs), and tubular bundle modules (TBMs) is accessed. The reservoir is coupled to the prime mover and the HTs. The coupling includes filling the prime mover and the HTs with liquid. The prime mover liquid is pressurized at a first pressure, sending liquid to a TBM and an HT. The TBM compresses a gas to a first pressure, using the first pressure liquid. The gas at a first pressure is sent to a second TBM. The liquid at a first pressure is further pressurized to a second pressure. The liquid is sent to a second TBM. The gas at a first pressure is further compressed, resulting in a gas at a second pressure. The second pressure gas is stored in a high-pressure tank.

The block diagram 400 shows an hydraulic transformer. The hydraulic transformer can be used for pressurizing a liquid. The liquid can include water, where the water can be obtained from a local source such as a pond, lake, stream, river, and so on. The water can be obtained from the ocean. More than one, or N, hydraulic transformers can be used for pressurizing a liquid. The N transformers can be chained in a series configuration, where a pressurized output of one hydraulic transformer can be further pressurized by another hydraulic transformer. Additional connections can be made between hydraulic transformers, effectively reversing the pressurizing. In embodiments, the N HTs comprise a two-chamber double-acting linear piston pressure volume exchanger. A liquid 410 can be sent into a first chamber of the two-chamber double-acting linear piston pressure volume exchanger. The liquid can be obtained from a prime piston, a previous hydraulic transformer, a preceding hydraulic transformer, and so on. The liquid that is obtained can include a liquid at a first liquid pressure 420. The first pressure can include 1 bar or the pressure of one atmosphere. The first liquid pressure can include a higher pressure, such as 5 bar, 10 bar, 25 bar, and so on. The first chamber can include a first piston 430. The first liquid pressure can force the first piston to display. In the example shown, the piston displaces to the right.

The first piston is coupled to a second piston 440. The second piston can pressurize a second liquid to a second liquid pressure 450. The second liquid can be within the second chamber of the two-chamber double-acting linear piston pressure volume exchanger. The second chamber can be smaller than the first chamber based on a ratio. In embodiments, the pressure of the liquid at a second liquid pressure is higher than the pressure of the liquid at a first liquid pressure. In embodiments, when piston 1 and piston 2 are not accelerating, the area of the first pressure chamber multiplied by the pressure in the first chamber is equal to the area of the second pressure chamber multiplied by the pressure in the second chamber. Thus, if the area of the second pressure chamber is less than the area of the first pressure chamber, the pressure of the liquid in the second pressure chamber must be higher than the liquid in the first pressure chamber. In a usage example, the ratio between the first chamber and the second chamber can be 5:1. If the first liquid pressure is 1 bar, then the second liquid pressure can be 5 bar. By using a series of hydraulic pistons each with a ratio of 5:1, with an input of 1 bar, the output of the first hydraulic transformer can be 5 bar, the output of the second hydraulic transformer can be 25 bar, the output of the third hydraulic transformer can be 125 bar, and so on. The liquid within the second chamber can be obtained from the liquid reservoir 412. The liquid within the second chamber can be from a previous hydraulic transformer. Liquid output from the second chamber 460 can be sent to a next hydraulic transformer for further pressurization.

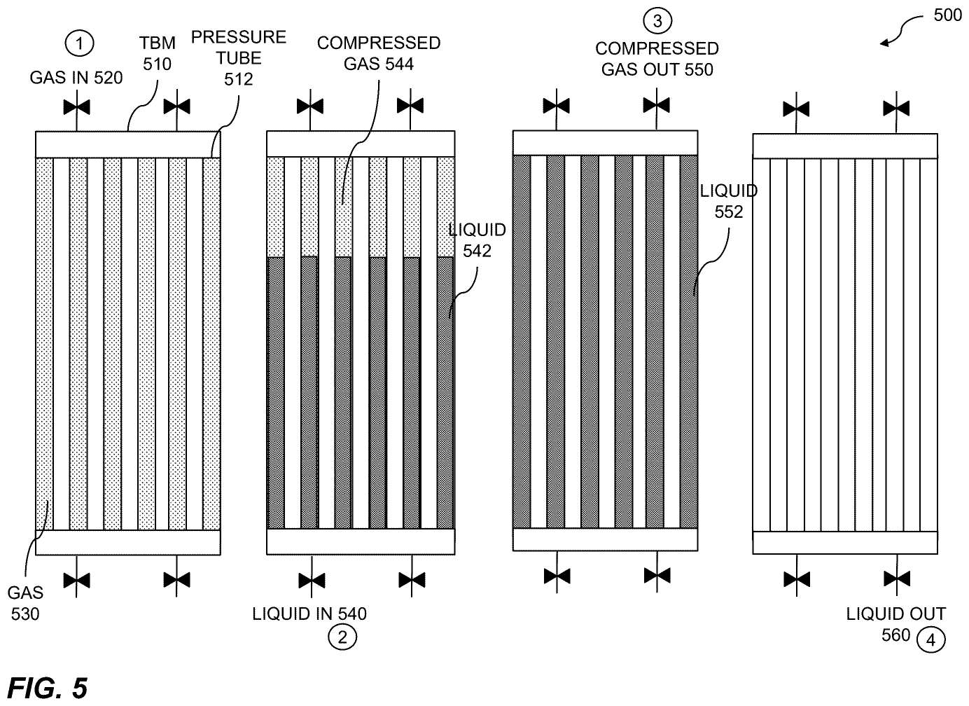

FIG. 5 is an example of compressing a gas with a tubular bundle module. A tubular bundle module (TBM) can include a plurality of tubes. The use of a plurality of tubes increases surface area of the tubing. The increased surface area can enable cooling of a gas during compression, heating of a gas during expansion, and so on. This can be accomplished by heat exchange with ambient air. During compression, the heat to be evacuated can include heat due to compression of the gas and/or condensation of the gas. During expansion, the heat to be evacuated can include the negative heat due to expansion of the gas and/or vaporization of the gas. The tubes can be operated based on a cycling technique that can include four cycles. The compressing a gas with a TBM enables energy storage. The compressing a gas with a tubular bundle module 500 begins with a first cycle 1. In the first cycle, a TBM 510 is filled with a gas 520. The TBM includes one or more pressure tubes 512. The gas can include atmospheric air, nitrogen, and so on. The gas can enter the TBM at a pressure. The pressure can include atmospheric pressure of 1 bar, a compressed pressure greater than 1 bar, and the like. The tubes of the TBM are shown to be filled 530 with the gas. In the second cycle, cycle 2, a liquid 540 is introduced into the TBM. The liquid can include environmental water, soft water, saltwater, etc. The liquid can include pressurized liquid, where the pressurized liquid is received from a prime mover, from another TBM, and so on. The pressurized liquid is shown 542 within the TBM. Introducing the pressurized liquid into the TBM compresses the gas 544 that was introduced into the TBM in the first cycle. In the third cycle, cycle 3, the liquid 552 within the TBM expels the compressed gas 550 from the TBM. In the fourth cycle, cycle 4, the liquid is expelled 560 from the TBM. The expelled liquid can be sent to a reciprocal energy storage system, to the liquid reservoir, and so on. In embodiments, the tubes are insulated to minimize heat transfer. In other embodiments, the TBMs comprise various geometries such as cylinders, rectangular prisms, and so on. The TBMs can be immersed in a liquid to evacuate generated heat to the immersion liquid rather than the ambient air. Various liquids can be used within the TBMs, including liquid carbon dioxide, liquid ammonia, liquid nitrogen, a liquid refrigerant, or another liquid. The liquid can be pressurized by a hydraulic transformer and then used to compress the gas in the TBMs. The gas that fills the TBMs can comprise a pressurized gas, a hot gas, or a gas that is combusted in the TBM. The gas can be chosen so it does not dissolve into the liquid that is introduced into the TBM.

Each of the N+1 TBMs in the ESS can be configured the same or differently. Different TBM configurations may allow for optimizing costs and operating efficiency. For example, in some applications, the earlier stages of the ESS, which operate at a lower pressure, may be optimized using only a single, larger cylindrical column, while later stages, which operate at a higher pressure, may be optimized using a plurality of smaller tubes. Similarly to shape and number variations, the material composition can vary within or among any of the N+1 TBMs.

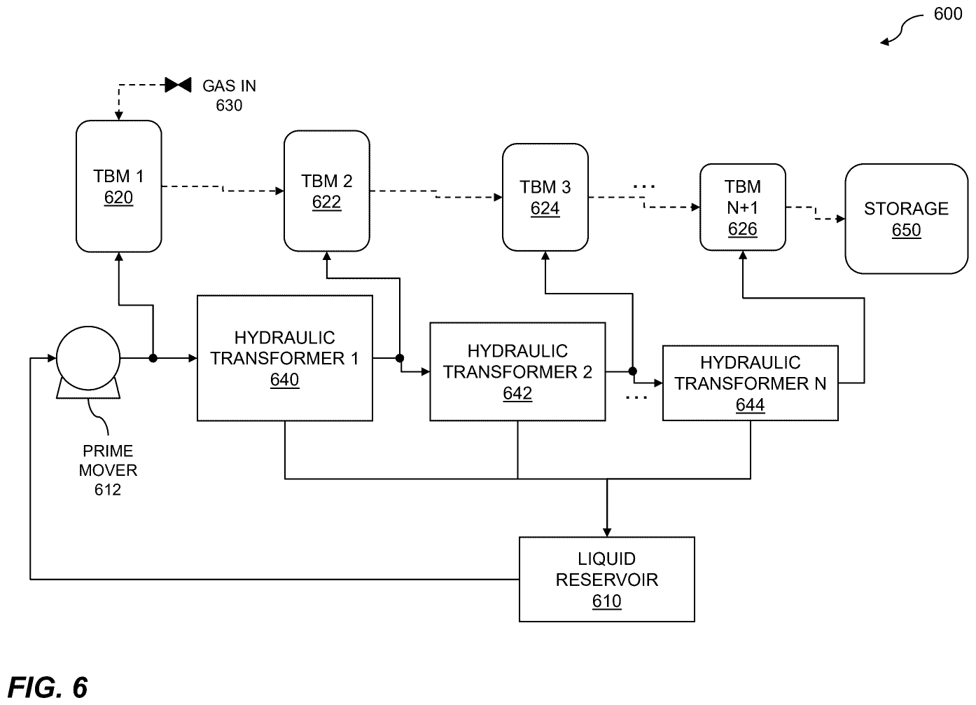

FIG. 6 is a block diagram for an energy storage system. The energy storage system can use a variety of energy sources, such as renewable energy sources, to pressurize a liquid such as surface water, soft water, or seawater. The pressurized liquid can be used to compress a gas such as air or nitrogen. The pressurizing the liquid and the compressing the gas can be accomplished using a plurality of stages to attain a high compression value such as 125 bar. The compressed gas can be stored in a high-pressure gas storage tank or vessel. The compressed gas can be stored for a duration of time, and later extracted. The extracted gas can be used to generate energy such as electrical energy by spinning a turbine, a pump-turbine, and so on. The system accomplishes energy storage with compressing gas using hydraulic transformers. In embodiments, the TBMs enable gas compression. In embodiments, the HTs enable liquid pressurization.

The energy storage system can be based on an apparatus for energy storage comprising: a number, N, of hydraulic transformers (HTs), wherein each of the N HTs comprises a two-chamber double-acting linear piston pressure volume exchanger, wherein the N HTs are interconnected with piping and computer-controlled switch valves, and wherein a first HT within the N HTs is coupled to the prime mover; a second number, N+1, of tubular bundle modules (TBMs), wherein an input and an output of each of the N HTs are coupled to a preceding TBM within the N+1 TBMs and a succeeding TBM within the N+1 TBMs; a liquid reservoir, wherein the liquid reservoir is coupled to each of the N HTs; and a high pressure gas storage tank, wherein the high pressure gas storage tank is coupled to a last TBM in the N+1 TBMs. An additional ESS apparatus, called a reciprocal ESS, can be coupled to the ESS apparatus. The reciprocal ESS can be identical to, or similar to, the ESS in terms of general componentry and control, but the reciprocal ESS can be employed to provide staged filling of a storage tank. After the ESS has gone through its compressing and pressurizing stages, the ESS must be reset and refilled to be ready for the next pressurizing/compressing cycle. While the ESS is being reset, one or more reciprocal energy storage apparatus can be in operation to provide a continuous stream of compressed gas into the storage container. In embodiments, one or more reciprocal energy storage apparatus enable phased operation of an energy storage system. In embodiments, the phased operation enables continuous gas compression and expansion operations.

The block diagram includes a liquid reservoir 610. The liquid reservoir can provide a liquid to a prime mover 612, where the prime mover can be used to pressurize a liquid, to send the liquid to a tubular bundle module such as TBM 1 620, and to a hydraulic transformer such as hydraulic transformer 1 640. The TBM is filled with a gas 630. The gas can include atmospheric air, nitrogen, and so on. The first TBM, TBM 1, can be coupled to a series of N additional TBMs such as TBM 2 622, TBM 3 624, and TBM N+1 626. Each of the subsequent or succeeding TBMs is shown is block diagram 600 as smaller than the previous TBM. The first hydraulic transformer, HT 1, can be coupled to a series of N−1 additional HTs such as hydraulic transformer 2 642, and hydraulic transformer N 644. Note that the outputs of the HTs are coupled to inputs of each of the TBMs from TBM 2 to TBM N+1. Pressurized fluid from an HT is used to further compress a gas in a TBM. The compressed gas produced by TBM N+1 can be stored in a storage tank 650. The storage tank can include a high-pressure storage tank, a high-pressure vessel, etc.

In the example shown, the operation of each stage, where a stage can include an HT and a TBM, can be unified such that all stages follow the prime mover. In embodiments, the pressurizing and the further pressurizing can occur simultaneously. That is, each of the hydraulic transformers can pressurize liquid substantially simultaneously. In embodiments, the compressing and the further compressing occur simultaneously. Similarly, each tubular module can compress a gas substantially simultaneously. The HTs and the TBM can also be used for depressurization of a liquid and decompression of a gas, respectively. The decompression or expansion of the gas can be used to extract energy from the stored, compressed gas. In a usage example, the extracted compressed gas can be used to spin a turbine to generate electrical energy. Compressed gas is sent to the next higher-pressure stage across all stages simultaneously. Thus, TBM 2 can send compressed gas to TBM 3, TBM 3 can send compressed gas to TBM 4, and so on. Pressurized liquid is sent to the next higher-pressure stage across all stages simultaneously. Multiple ranks of TBMs can be used to alternate steps in the cycle. A multiple rank of TBMs can be associated with a reciprocal energy storage system. In embodiments, no gas energy is lost during sequencing because gas pressures are maintained during the sequencing. Minimal liquid energy is lost due to friction because the gas pressures are maintained. In embodiments, the combination of “lock-step” sequencing of the various stages and dynamic control of the prime mover can enable the energy storage system to respond to changes in power input, power output demand, and gas reservoir pressure. Recall that the one or more HTs can be drained. The liquid drained from one or more HTs can be required for the liquid reservoir 610.

The ESS depicted in FIG. 6 can include various configurations. In one configuration, additional HTs and TBMs can be added, wherein the additional HTs and TBMs are coupled to a second storage tank as well as the liquid reservoir to comprise a second system. This configuration can provide constant energy storage, alternating between two systems. As one system is pressurizing, the second can be draining and vice versa. The second system can include a separate liquid reservoir. Applications of the ESS can also vary. For example, the ESS can comprise an impulse pump. An impulse pump can use pressure created by a compressed gas to drive movement of a liquid. Thus, any of the output stages of a TBM can be used to drive the impulse pump. The impulse pump can include one or more cycles including a pump cycle and a drain cycle. In the pump cycle, the hydraulic transformers can provide a pressure multiplying factor such as 5:1. This pressure can be used to compress a gas in a coupled TBM. The TBM can be used to drive the impulse pump or can be used to further compress a gas in a successive TBM with a successive hydraulic transformer. The output of the successive TBM can then be used to drive the pumping action. Any number of stages comprising a TBM and a hydraulic transformer can be included. As additional stages are added, higher pressures can be achieved by the pump. Thus, in a system with three hydraulic transformers with a 5:1 ratio and a prime mover to condition an input liquid at 5 bar, a total pressure of 625 bar can be achieved. With a fourth stage, more than 3,000 bar is possible, forming an ultra-high pressure impulse pump. With such high pressure, additional applications are possible. For example, the system configured as above can supply ultra-high-pressure water required for a water jet cutter. In another usage, the ultra-high pressure can be used for ballistics, fire suppression, or even riot control.

The ESS depicted in FIG. 6 can include various stages, fluids, and circuits. Each component of the ESS can be controlled with one or more computer-controlled switch valves. The computer-controlled switch valves can control flow, volume, speed of compression/expansion, and so on. Electrical switches can enable or disable certain parts of the system, providing flexibility. For example, as described above, a TBM and a hydraulic transformer can comprise a stage. Any number of stages can be included in the overall system, each providing a compression multiplier. In some cases, ESS output requirements may be lower (such as late at night) than at other times (such as during the day). When output requirements are lower, the system can be configured to shut down one or more states, saving power. In addition, the system can slow the rate of compression during times of low projected energy demand, increasing overall operational efficiency. Various system configurations can be used. These system configurations can include the size of the prime piston, number of stages, liquid selected, gas used, pressure multiplier, overall pressure desired, and so on. Customizations, such as the timing of opening and closing valves, the speed at which the prime piston operates, and the speed of compression of the HTs, can change operational efficiency. Many different materials may be used in the ESS. For example, the liquid can comprise water, sea water, soft water, treated water, ammonia, oil, and so on. The gas can comprise atmospheric air, compressed air, or another gas. Other variables can be considered including overall power demand, timing of the demand, seasonality of the demand, temperature, weather, size of the storage tank, and so on. All these configurations and factors can be intelligently controlled by a control system coupled to the ESS. The control system can automatically configure the ESS to operate in the most efficient mode. The control system can use a machine learning model to learn operational data and increase the efficiency for the overall system. The control system can use a table of pre-calculated look up tables, based on modelling, to optimize operational variables.

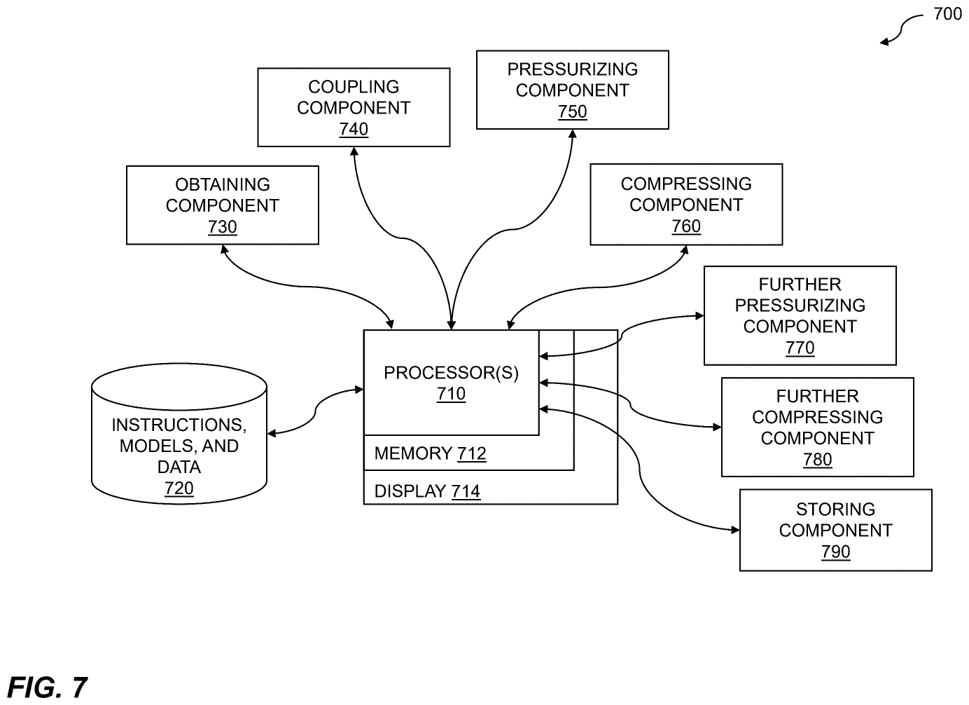

FIG. 7 is a system diagram for energy storage with compressed gas using hydraulic transformers. An energy storage system is enabled based on compressed gas using hydraulic transformers. The system 700 can include one or more processors 710 and a memory 712 which stores instructions. The memory 712 is coupled to the one or more processors 710, wherein the one or more processors 710 can execute instructions stored in the memory 712. The memory 712 can be used for storing instructions, for storing databases for energy storage systems, for storing switching valve and non-return valve configurations, and the like. Information regarding energy storage with compressing gas using hydraulic transformers can be shown on a display 714 connected to the one or more processors 710. The display can comprise a television monitor, a projector, a computer monitor (including a laptop screen, a tablet screen, a netbook screen, and the like), a smartphone display, a mobile device, or another electronic display.

The system 700 includes instructions, models, and data 720. The data can include information on energy storage systems; information on the controlling of switching valves, non-return valves, or smart valves; metadata about energy storage; and the like. In embodiments, the instructions, models, and data 720 are stored in a networked database, where the networked database can be a local database, a remote database, a distributed database, and so on. The instructions, models, and data 720 can include instructions for pressurizing a liquid, compressing a gas, etc. The instructions can control one or more pressurization techniques and compression techniques. The instructions can control a prime mover for pressurizing the liquid to a first liquid pressure using hydraulic transformers. The instructions can further control sending the pressurized liquid to a tubular bundle module (TBM), where the TBM compresses the gas to a first gas pressure. The instructions, models, and data can include further instructions for pressurizing the liquid to a second liquid pressure using a second HT. The instructions, models, and data can include instructions for further compressing the gas by a second TBM to a second liquid pressure, using the liquid at the second liquid pressure. The instructions, models, and data can further include instructions for storing the compressed gas in an enclosure. The gas can include atmospheric air, and the enclosure can include a vessel such as a high-pressure gas storage tank. The instructions, models, and data can further include instructions for releasing the compressed gas from the high-pressure storage tank. The compressed gas can be released into a purification unit, a dryer, and so on. The instructions, models, and data can control and send the compressed gas to spin a turbine, a pump-turbine, and so on. The spinning turbine can be used to generate energy such as electrical energy.

The system 700 includes an obtaining component 730. The obtaining component 730 can access an energy storage system (ESS). The energy storage system can be used to store a variety of types of energy such as electrical energy, pressurized liquid, compressed gas, and so on. The ESS includes a variety of elements including a prime mover, a liquid reservoir, N hydraulic transformers (HTs), and N+1 tubular bundle modules (TBMs). The elements can be colocated on a movable platform, installed near sources of liquid and gas, and the like. The ESS can further include a high-pressure gas storage tank for storing a compressed gas (discussed below). The N HTs are interconnected with piping and computer-controlled switch valves. The piping and the computer-controlled switch valves can control and direct the flow of liquid, pressurized liquid, gas, and compressed gas. An input and an output of each of the N HTs are coupled to a preceding TBM within the N+1 TBMs and a succeeding TBM within the N+1 TBMs. The HTs can be “daisy chained” together in a series configuration, as can the TBMs. In other embodiments, the ESS provides substantially isothermal operation. In other embodiments, the N HTs can include a two-chamber double-acting linear piston pressure volume exchanger.

The system 700 includes a coupling component 740. The coupling component 740 can couple the liquid reservoir to the prime mover and the N HTs. The coupling can be accomplished using piping and computer-controlled switch valves as discussed above. The coupling includes filling a chamber within the prime mover with a liquid from the liquid reservoir and filling a chamber within each of the N HTs with the liquid from the liquid reservoir. The liquid can be obtained from one or more local sources such as surface water, ground water, a lake or pond, a river, and so on. In embodiments, the liquid can include soft water. The soft water can include a content of calcium carbonate such as 0-3 grains per gallon of water. In other embodiments, the liquid can include seawater. The seawater can be filtered to remove debris, plants, animals, etc.

The system 700 includes a pressurizing component 750. The pressurizing component can pressurize the liquid within the chamber of the prime mover. The pressurizing can be accomplished by a weight coupled to a piston, where the piston can pressurize the liquid within the chamber. In embodiments, the prime mover can include a prime piston. The piston can be raised to a position suitable to accomplish the pressurizing. In embodiments, moving the piston can include resetting the ESS. The resetting can include moving, with a motor, the prime piston. The motor can include an electric motor. The electric motor can be powered by one or more green energy sources such as solar, wind, wave action, and so on. The pressurizing results in a liquid at a first liquid pressure. The first liquid pressure can be measured in bar units. The pressurizing sends the liquid at a first liquid pressure to a first TBM within the N+1 TBMs and a first HT within the N HTs. The system 700 includes a compressing component 760. The compressing component 760 can compress, by the first TBM, using the liquid at a first liquid pressure, a gas. The gas can include atmospheric air, filtered air, nitrogen, and so on. The compressing produces a gas at a first gas pressure. The gas at a first gas pressure is sent to a second TBM. The sending can be accomplished using the interconnecting piping and computer-controlled switch valves. The sending the gas at the first pressure to a second TBM can accomplish further compression of the gas (discussed below)

The system 700 includes a further pressurizing component 770. The further pressurizing component can further pressurize, by the first HT, the liquid at a first liquid pressure. The further pressurizing results in a liquid at a second pressure. In embodiments, the pressure of the liquid at a second liquid pressure is higher than the pressure of the liquid at a first liquid pressure. The further pressurizing includes sending the liquid at a second liquid pressure to a second TBM within the N+1 TBMs. The sending the liquid at the second liquid pressure can be accomplished using the interconnected piping and computer-controlled switch valves. In other embodiments, the pressurizing and the further pressurizing can occur simultaneously. The liquid can be further pressurized. In other embodiments, the ESS can include a second HT, wherein the second HT converts the liquid at a second liquid pressure to a liquid at a third liquid pressure.

The system 700 includes a further compressing component 780. The further compressing component can further compress, by a second TBM within the N+1 TBMs, using the liquid at a second liquid pressure, the gas at a first gas pressure. The further compressing results in a gas at a second gas pressure. In embodiments, the pressure of the gas at a second gas pressure is higher than the pressure of the gas at a first gas pressure. In other embodiments, the compressing and the further compressing can occur simultaneously. The pressurized liquid and the compressed gas can be further pressurized and further compressed, respectively. In embodiments, the ESS includes a second HT, wherein the second HT converts the liquid at a second liquid pressure to a liquid at a third liquid pressure.

The pressurizing, the further pressurizing, the compressing, and the further compressing components can be reset. Further embodiments can include refilling the chamber within the prime mover with a liquid from the liquid reservoir and refilling the chamber within each of the N HTs with the liquid from the liquid reservoir. The pressurizing, further pressurizing, compressing, and further compressing can be repeated. In embodiments, a reciprocal ESS is coupled to the ESS to provide continuous gas compression and expansion operations.

The system 700 includes a storing component 790. The storing component 790 can store, in a high-pressure gas storage tank, the gas at a second gas pressure. The high-pressure gas storage tank can include an insulated tank, a pressure vessel, and so on. The high-pressure tank can be placed on the surface of the ground, on a tower or platform, within a buried tank, in a subterranean cavern, in an underwater tank or vessel, and so on.

The system 700 can include a system for energy storage comprising: a prime mover, N hydraulic transformers (HTs), N+1 tubular bundle modules (TBMs), a liquid reservoir, and a high pressure gas storage tank, which, when coupled with piping and computer-controlled switch valves, are configured to: access an energy storage system (ESS), wherein the ESS comprises a prime mover, a liquid reservoir, N hydraulic transformers (HTs), and N+1 tubular bundle modules (TBMs), wherein the N HTs are interconnected with piping and computer-controlled switch valves, and wherein an input and an output of each of the N HTs are coupled to a preceding TBM within the N+1 TBMs and a succeeding TBM within the N+1 TBMs; couple the liquid reservoir to the prime mover and the N HTs, wherein the coupling includes filling a chamber within the prime mover with a liquid from the liquid reservoir and filling a chamber within each of the N HTs with the liquid from the liquid reservoir; pressurize the liquid within the chamber of the prime mover, wherein the pressurizing results in a liquid at a first liquid pressure wherein the pressurizing sends the liquid at a first liquid pressure to a first TBM within the N+1 TBMs and a first HT within the N HTs; compress by the first TBM, using the liquid at a first liquid pressure, a gas, wherein the compressing produces a gas at a first gas pressure, and wherein the gas at a first gas pressure is sent to a second TBM; further pressurize, by the first HT, the liquid at a first liquid pressure, wherein the further pressurizing results in a liquid at a second pressure, wherein the further pressurizing includes sending the liquid at a second liquid pressure to a second TBM within the N+1 TBMs; further compress, by a second TBM within the N+1 TBMs, using the liquid at a second liquid pressure, the gas at a first gas pressure, wherein the further compressing results in a gas at a second gas pressure; and store, in a high pressure gas storage tank, the gas at a second gas pressure.

The system 700 can include an apparatus for energy storage comprising: a prime mover, wherein the prime mover includes a prime piston, a motor, and a liquid chamber; a number, N, of hydraulic transformers (HTs), wherein each of the N HTs comprises a two-chamber double-acting linear piston pressure volume exchanger, wherein the N HTs are interconnected with piping and computer-controlled switch valves, and wherein a first HT within the N HTs is coupled to the prime mover; a second number, N+1, of tubular bundle modules (TBMs), wherein an input and an output of each of the N HTs are coupled to a preceding TBM within the N+1 TBMs and a succeeding TBM within the N+1 TBMs; a liquid reservoir, wherein the liquid reservoir is coupled to each of the N HTs; and a high pressure gas storage tank, wherein the high pressure gas storage tank is coupled to a last TBM in the N+1 TBMs.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for storing energy comprising:
accessing an energy storage system (ESS), wherein the ESS comprises a prime mover, a liquid reservoir, N hydraulic transformers (HTs), and N+1 tubular bundle modules (TBMs), wherein the N HTs are interconnected with piping and computer-controlled switch valves, and wherein an input and an output of each of the N HTs are coupled to a preceding TBM within the N+1 TBMs and a succeeding TBM within the N+1 TBMs;
coupling the liquid reservoir to the prime mover and the N HTs, wherein the coupling includes filling a chamber within the prime mover with a liquid from the liquid reservoir and filling a chamber within each of the N HTs with the liquid from the liquid reservoir;
pressurizing the liquid within the chamber of the prime mover, wherein the pressurizing results in a liquid at a first liquid pressure wherein the pressurizing sends the liquid at a first liquid pressure to a first TBM within the N+1 TBMs and a first HT within the N HTs;
compressing by the first TBM, using the liquid at a first liquid pressure, a gas, wherein the compressing produces a gas at a first gas pressure, and wherein the gas at a first gas pressure is sent to a second TBM;
further pressurizing, by the first HT, the liquid at a first liquid pressure, wherein the further pressurizing results in a liquid at a second pressure, wherein the further pressurizing includes sending the liquid at a second liquid pressure to a second TBM within the N+1 TBMs;
further compressing, by a second TBM within the N+1 TBMs, using the liquid at a second liquid pressure, the gas at a first gas pressure, wherein the further compressing results in a gas at a second gas pressure; and
storing, in a high-pressure gas storage tank, the gas at a second gas pressure.

2. The method of claim 1 wherein the pressurizing and the further pressurizing occur simultaneously.

3. The method of claim 1 wherein the compressing and the further compressing occur simultaneously.

4. The method of claim 1 wherein the ESS includes a second HT, wherein the second HT converts the liquid at a second liquid pressure to a liquid at a third liquid pressure.

5. The method of claim 1 wherein the prime mover includes a prime piston.

6. The method of claim 5 further comprising moving, with a motor, the prime piston.

7. The method of claim 1 wherein the prime mover comprises a motor-driven pump.

8. The method of claim 1 further comprising resetting the ESS.

9. The method of claim 8 further comprising refilling the chamber within the prime mover with liquid from the liquid reservoir and refilling the chamber within each of the N HTs with liquid from the liquid reservoir.

10. The method of claim 1 wherein a reciprocal ESS is coupled to the ESS to provide continuous gas compression and expansion operations.

11. The method of claim 1 wherein the N HTs each comprise a two-chamber double-acting linear piston pressure volume exchanger.

12. The method of claim 11 wherein the two-chamber double-acting linear piston pressure volume exchanger enables power leveling over an entire operating cycle.

13. The method of claim 1 wherein the liquid comprises soft water.

14. The method of claim 1 wherein the liquid comprises sea water.

15. The method of claim 1 wherein the ESS provides substantially isothermal operation.

16. The method of claim 1 wherein pressure of the liquid at the second liquid pressure is higher than a pressure of the liquid at the first liquid pressure.

17. The method of claim 1 further comprising releasing compressed gas from the high-pressure gas storage tank back into the ESS running in expansion mode.

18. The method of claim 17 further comprising extracting energy from the ESS running in expansion mode.

19. An apparatus for energy storage comprising:
a prime mover, wherein the prime mover includes a prime piston, a motor, and a liquid chamber;
a number, N, of hydraulic transformers (HTs), wherein each of the N HTs comprises a two-chamber double-acting linear piston pressure volume exchanger, wherein the N HTs are interconnected with piping and computer-controlled switch valves, and wherein a first HT within the N HT's is coupled to the prime mover;
a second number, N+1, of tubular bundle modules (TBMs), wherein an input and an output of each of the N HTs are coupled to a preceding TBM within the N+1 TBMs and a succeeding TBM within the N+1 TBMs;
a liquid reservoir, wherein the liquid reservoir is coupled to each of the N HTs; and
a high-pressure gas storage tank, wherein the high-pressure gas storage tank is coupled to a last TBM in the N+1 TBMs.

20. The apparatus of claim 19 wherein the TBMs enable gas compression.

21. The apparatus of claim 19 wherein the HTs enable liquid pressurization.

22. The apparatus of claim 19 wherein one or more reciprocal energy storage apparatus enable phased operation of an energy storage system.

23. A system for energy storage comprising:
a prime mover, N hydraulic transformers (HTs), N+1 tubular bundle modules (TBMs), a liquid reservoir, and a high-pressure gas storage tank, which, when coupled with piping and computer-controlled switch valves, are configured to:
access an energy storage system (ESS), wherein the ESS comprises a prime mover, a liquid reservoir, N hydraulic transformers (HTs), and N+1 tubular bundle modules (TBMs), wherein the N HTs are interconnected with piping and computer-controlled switch valves, and wherein an input and an output of each of the N HTs are coupled to a preceding TBM within the N+1 TBMs and a succeeding TBM within the N+1 TBMs;
couple the liquid reservoir to the prime mover and the N HTs, wherein coupling includes filling a chamber within the prime mover with a liquid from the liquid reservoir and filling a chamber within each of the N HTs with the liquid from the liquid reservoir; pressurize the liquid within the chamber of the prime mover, wherein the pressurizing results in a liquid at a first liquid pressure wherein pressurizing sends the liquid at a first liquid pressure to a first TBM within the N+1 TBMs and a first HT within the N HTs;
compress by the first TBM, using the liquid at a first liquid pressure, a gas, wherein compressing produces a gas at a first gas pressure, and wherein the gas at a first gas pressure is sent to a second TBM;
further pressurize, by the first HT, the liquid at a first liquid pressure, wherein further pressurizing results in a liquid at a second pressure, wherein further pressurizing includes sending the liquid at a second liquid pressure to a second TBM within the N+1 TBMs;
further compress, by a second TBM within the N+1 TBMs, using the liquid at a second liquid pressure, the gas at a first gas pressure, wherein further compressing results in a gas at a second gas pressure; and
store, in a high-pressure gas storage tank, the gas at a second gas pressure.
